(19) United States
(12) Patent Application Publication
(10) Pub. No.: US 2019/0265954 A1
(43) Pub. Date: Aug. 29, 2019

(54) APPARATUS AND METHOD FOR ASSISTING DISCOVERY OF DESIGN PATTERN IN MODEL DEVELOPMENT ENVIRONMENT USING FLOW DIAGRAM

(71) Applicant: HITACHI, LTD., Tokyo (JP)

(72) Inventors: Masanori KANEKO, Tokyo (JP); Hideki NAKAMURA, Tokyo (JP); Junji KINOSHITA, Tokyo (JP)

(73) Assignee: HITACHI, LTD., Tokyo (JP)

(21) Appl. No.: 16/131,897

(22) Filed: Sep. 14, 2018

(30) Foreign Application Priority Data
Feb. 26, 2018 (JP) 2018-031590

(51) Int. Cl. G06F 8/20; G06F 8/77

(52) U.S. Cl. CPC G06F 8/20; G06F 8/77

(57) ABSTRACT

A design pattern discovery assist apparatus presents one or more second node candidates, which are one or more candidates of a second node, when a first node is selected regarding a flow in the middle of being edited. The first node is any node corresponding to one type of node between an input node and an output node. The second node is a node corresponding to the first node among nodes corresponding to any type between the other type of node between the input node and the output node and an input/output node, which serves as both the input and the output nodes. When any second node candidate is selected as the second node, the assist apparatus presents one or more partial flow candidates which are one or more candidates of a partial flow between the first node and the second node.

### BACKGROUND OF THE INVENTION

### 1. Field of the Invention

The present invention relates generally to a technique for supporting software development in a model development environment using a flow diagram.

### 2. Description of the Related Art

In software development, there is a model development environment in which software operated by describing a model diagram can be developed without describing a source code. For example, there is a model development environment, such as SimuLink (trademark) of MathWorks, Inc., which describes Node-RED (https://nodered.org/), signal processing, and control logic, executable by describing HTTP communication, connection with a database, or the like using a flow diagram, as a block diagram and can generate an executable source code. In such a model development environment, components and processing units of software are nodes, and the nodes are connected by edges.

The node and edge are terms in a directed graph, and both the flow diagram in Node-RED and the block diagram in SimuLink can be regarded as directed graphs. In the present specification, the flow diagram, the block diagram, and the directed graph are synonymous, the flow diagram can be simply referred to as a “flow”, and the “flow” and a “graph” are synonymous. A part of a certain graph will be referred to as a “subgraph”, and similarly, a part of a certain flow will be referred to as a “partial flow”. Then, for the partial flow, a term, “whole flow” will be used as a term representing not a part of the flow but the whole flow.

In a method of describing the source code, there is a standard procedure referred to as a “design pattern”. The source code following the design pattern has higher maintainability than a source code that does not follow the design pattern (for example, a source code of a simple partial flow (or whole flow) having no value as a design pattern), and thus, contributes to software quality and productivity of development. Similarly, there is a design pattern even in the description of the flow diagram in the model development environment. For example, in Node-RED, a series of processes of receiving an HTTP request at an HTTP-in node, then, executing a process of extracting a body and a query included in the HTTP request by a function node, sending the extracted data to another node, and finally returning a response of the HTTP request at an HTTP-out node, is generic and corresponds to the design pattern. A developer can expect improvement in quality of software to be developed and development efficiency by developing the software following the design pattern.

As a technique in the directed graph, there are a technique (JP 2016-177667 A) capable of easily confirming a difference between an unchanged block diagram and a changed block diagram and a technique (JP 2017-097698 A) capable of efficiently detecting an identical subgraph or a similar subgraph while calculating a similarity between subgraphs.

### SUMMARY OF THE INVENTION

Since the flow diagram is the directed graph, it is conceivable to use the technique in JP 2016-177667 A or JP 2017-097698 A in order to discover a design pattern in the flow diagram. If it is possible to discover the design pattern, it is possible to expect reduction in burden on the developer regarding software development.

However, there is a plurality of types of nodes in the model development environment using the flow diagram. Specifically, for example, there are a node (input node) that receives an input from the outside of a system described in the flow diagram, a node (output node) for output to the outside of the system described in the flow diagram, and a node performing both the input and output (input/output node which is a node that serves as both the input node and the output node). Examples of types of nodes other than the input node, the output node, and the input/output node further include a node for conditional branching, a node for delaying processing, a node for control such as a node outputting single data to a plurality of nodes, and a node for numerical operation.

Accordingly, when it is attempted to discover a design pattern using the technique in JP 2016-177667 A or JP 2017-097698 A, it is likely to obtain a result that miscellaneously includes a partial flow including the input node, a partial flow including the output node, a partial flow including the node for both the input and output, a partial flow including the node for conditional branching, a partial flow including the node for numerical operation, and the like. This result may also include a useful partial flow which is suitable as the design pattern, but there is a high possibility that a lot of useless partial flows are included. For example, when a plurality of partial flows combining the node for conditional branching and the node for delaying processing is found, it is difficult for the developer to utilize the partial flows unless it is possible to know any input node or output node for which the flow is to be executed, Further, a type of processing that the developer is trying to develop is not considered by only investigating an appearance frequency of a partial flow from an existing flow diagram group, and thus, it takes time to look for a partial flow suitable for reference. Examples of the type of processing include reception of an HTTP request, use of a database, control of a motor, voice signal processing, and the like. When partial flows that do not conform to the type of processing that the developer is trying to develop is presented, it is difficult for the developer to utilize those partial flows.

The invention has been made in view of such a problem, and an object thereof is to assist discovery of a useful design pattern in a model development environment using a flow diagram.

A design pattern discovery assist apparatus presents one or more second node candidates, which are one or more candidates of a second node, when a first node is selected regarding a flow in the middle of being edited in a model development environment using a flow diagram. The first node is any node corresponding to one type of node between an input node and an output node. The second node is a node corresponding to the first node among nodes corresponding to any type between the other type of node between the input node and the output node and an input/output node which is a type of node serving as both the input node and the output node. When any second node candidate is selected as the second node from the one or more second node candidates, the assist apparatus presents one or more partial flow candidates which are one or more candidates of a partial flow between the first node and the second node.

According to the invention, one or more second node candidates are presented when the first node is selected, and one or more partial flow candidates between the two nodes are presented when any second node candidate is selected. Thus, it is possible to efficiently discover a useful pattern that is suitable for being referred to as the design pattern, thereby improving development efficiency in the model development environment using the flow diagram.

### BRIEF DESCRIPTION OF THE DRAWINGS

FIG. 1 is a diagram illustrating a configuration of the entire system including a design pattern discovery assist apparatus (hereinafter referred to as an assist apparatus) according to an embodiment of the invention;

FIG. 2 is a diagram illustrating a series of processes performed by the assist apparatus;

FIG. 3 is a diagram illustrating an example of a partial flow score table;

FIG. 4 is a diagram illustrating an example of an input/output score table;

FIG. 5 is a diagram illustrating an example of a whole flow;

FIG. 6 is a diagram illustrating an example of a search node table;

FIG. 7 is a diagram illustrating an example of a search start/end pair table;

FIG. 8 is a diagram illustrating an example of processing A;

FIG. 9 is a diagram illustrating an example of a partial flow score table (before processing B) for a pair (A->B);

FIG. 10 is a diagram illustrating an example of a partial flow score table (before the processing B) for a pair (A->C);

FIG. 11 is a diagram illustrating an example of a partial flow score table (before the processing B) for a pair (B, B, C->X);

FIG. 12 is a diagram illustrating an example of a partial flow score table (before the processing B) for a pair (A, A, A->X);

FIG. 13 is a diagram illustrating an example of a partial flow score table (before the processing B) for a pair (B, B, C->X, Y);

FIG. 14 is a diagram illustrating an example of a partial flow score table (before the processing B) for a pair (A, A, A->X, Y);

FIG. 15 is a diagram illustrating an example of the processing B;

FIG. 16 is a diagram illustrating an example of processing C;

FIG. 17 is a diagram illustrating an example of an edge coefficient table;

FIG. 18 is a diagram illustrating an example of a partial flow score table (after the processing B) for a pair (A->B);

FIG. 19 is a diagram illustrating an example of a partial flow score table (after the processing B) for a pair (A->C);

FIG. 20 is a diagram illustrating an example of a partial flow score table (after the processing B) for a pair (B, B, C->X);

FIG. 21 is a diagram illustrating an example of a partial flow score table (after the processing B) for a pair (A, A, A->X);

FIG. 22 is a diagram illustrating an example of a partial flow score table (after the processing B) for a pair (B, B, C->X, Y);

FIG. 23 is a diagram illustrating an example of a partial flow score table (after the processing B) for a pair (A, A, A->X, Y);

FIG. 24 is a diagram for describing a typical example of transition of a candidate presentation;

FIG. 25 is a sequence diagram corresponding to the transition of the candidate presentation in FIG. 24; and

FIG. 26 is a diagram illustrating an example of a tag coefficient table.

### DESCRIPTION OF THE PREFERRED EMBODIMENTS

In the following description, an “interface unit” may be one or more interfaces. The one or more interfaces may include at least a communication interface unit between a user interface unit and a communication interface unit. The user interface unit may be at least one I/O device among one or more I/O devices (for example, an input device (for example, a keyboard and a pointing device) and an output device (for example, a display device) and a display computer, or an interface device for the at least one I/O device instead of or in addition to the at least one I/O device. The communication interface unit may be one or more communication interface devices. The one or more communication interface devices may be one or more homogeneous communication interface devices (for example, one or more network interface cards (NICs)), or may be two or more heterogeneous communication interface devices (for example, NIC and a host bus adapter (HBA)).

In the following description, a “memory unit” represents one or more memories, and may typically be a main storage device. At least one memory in the memory unit may be a volatile memory or a nonvolatile memory.

In the following description, a “PDEV unit” represents one or more PDEVs, and may typically be an auxiliary storage device. The “PDEV” means a physical storage device, and typically is a nonvolatile storage device, for example, a hard disk drive (HDD) or a solid state drive (SSD).

In the following description, a “storage unit” represents at least one (typically, at least the memory unit) of the memory unit and the PDEV unit.

In the following description, a “processor unit” represents one or more processors. The at least one processor is typically a microprocessor such as a central processing unit (CPU), but may be another type of processor such as a graphics processing unit (GPU). The at least one processor may be a single-core or multi-core processor. The at least one processor may be a processor in a broad sense such as a hardware circuit that performs some or all of processes (for example, a field-programmable gate array (FPGA) or an application specific integrated circuit (ASIC)).

In the following description, a function is sometimes described with an expression of a “kkk unit” (excluding the interface unit, the storage unit, and the processor unit), but the function may be implemented when one or more computer programs are executed by the processor unit or may be implemented by one or more hardware circuits. In the case where the function is implemented by the processor unit executing the program, a predetermined process is performed appropriately using the storage unit and/or the communication interface unit, and thus, the function may be configured as at least a part of the processor unit. A process described with the function as a subject may be a process performed by the processor unit or an apparatus having the processor unit. The program may be installed from a program source. The program source may be a recording medium (for example, a non-transitory recording medium) readable by, for example, a program distribution computer or a computer. The description of each function is an example, a plurality of functions may be integrated into one function or one function may be divided into a plurality of functions.

In the following description, a structural body in which an output can be obtained with respect to an input is sometimes described using an expression of an “xxx table”, but the structural body may be data having an arbitrary structure or may be a learning model such as a neural network that generates an output for an input. Therefore, the “xxx table” can be referred to as an “xxx structural body”. In the following description, a configuration of each table is an example, one table may be divided into two or more tables, or all or some of two or more tables may be one table.

In the following description, reference signs are used in the case of describing the same type of elements without discrimination, and IDs of elements are used in the case of describing the same type of elements discriminatively. For example, it is described as a “node 501” in the case of describing nodes without particularly distinguishing the nodes from each other, and it is described as a “node A”, and a “node B” in the case of describing the individual nodes discriminatively.

In the following description, a “data set” represents a piece of logical electronic data viewed from a program such as an application program, and for example, may be any of a record, a file, a key value pair, and a tuple.

An embodiment of the invention will be described.

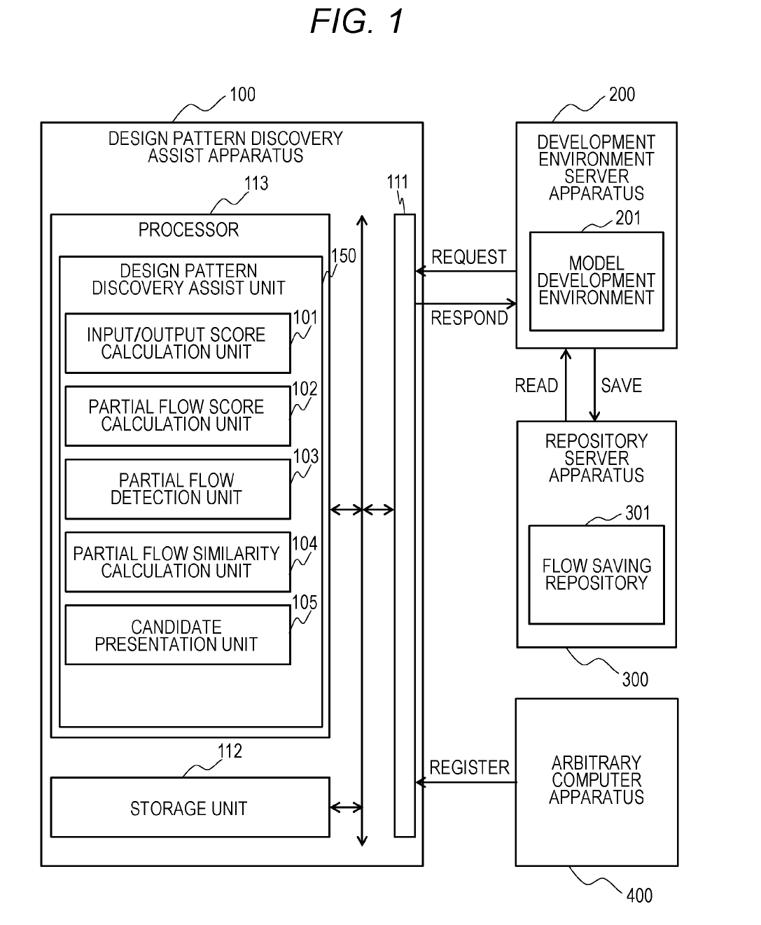

First, FIG. 1 is a configuration diagram of the entire system including a design pattern discovery assist apparatus (hereinafter referred to as an assist apparatus) 100 according to the embodiment of the invention.

The assist apparatus 100 is an apparatus for assisting discovery of a design pattern in a model development environment using a flow diagram. In the entire system including the assist apparatus 100, there are a development environment server apparatus 200 and a repository server apparatus 300. Each of the apparatuses 100, 200, and 300 is a computer apparatus as one or more computers. A developer develops a flow using a model development environment 201 using the flow diagram which is software to be executed on the development environment server apparatus 200. The developed flow is handled as a file (an example of the data set) and saved in the flow-saving repository 301 which is software existing in the repository server apparatus 300.

The assist apparatus 100 reads files of a plurality of flows saved in the flow-saving repository 301. In the embodiment, the flow saved in the flow-saving repository 301 and the flow read from the flow-saving repository 301 are referred to as a “whole flow” to be clearly distinguished from a partial flow.

As illustrated in FIG. 1, the assist apparatus 100, the development environment server apparatus 200, and the repository server apparatus 300 communicate with each other via a communication network such as the Internet. The apparatuses 100, 200, and 300 may be separate apparatuses, or two or more of the apparatuses 100, 200, and 300 may be configured, as one computer apparatus, to include at least some functions of functions 101, 102, 103, 104, 105, 201, and 301 to be described later. The functions 101, 102, 103, 104, 105, 201, and 301 may be implemented, for example, by the processor unit executing one or more computer programs.

As the implementation of the embodiment, the assist apparatus 100 includes an interface unit 111, a storage unit 112, and a processor unit 113 connected to the interface unit 111 and the storage unit 112. As the processor unit 113 executes a computer program (for example, a design pattern discovery assist program) stored in the storage unit 112, a function 150 (the functions 101, 102, 103, 104, and 105) functions as a web application, and the model development environment 201 using the flow diagram is an existing system (for example, Node-RED) that provides a model development environment, and the flow-saving repository 301 is an existing system (for example, a version management system such as Git (registered trademark)).

The assist apparatus 100 includes design pattern discovery assist unit (hereinafter referred to as an assist unit) 150 that assists discovery of a design pattern as a function. The assist unit 150 includes: an input/output score calculation unit 101 that calculates an input/output score; a partial flow score calculation unit 102 that calculates a partial flow score; a partial flow detection unit 103 that detects a partial flow; a partial flow similarity calculation unit 104 that calculates a partial flow similarity (hereinafter, similarity); and a candidate presentation unit 105 that provides candidates of a node and a partial flow.

The assist apparatus 100 receives information and a threshold of the similarity to be recorded in a search node table, a tag coefficient table, and an edge coefficient table, which will be described later, from an arbitrary computer apparatus 400 and registers the information and the threshold.

The assist apparatus 100 reads a plurality of whole flows stored in the flow-saving repository 301 and processes the read flows, thereby assisting discovery of a useful design pattern in the model development environment using the flow diagram.

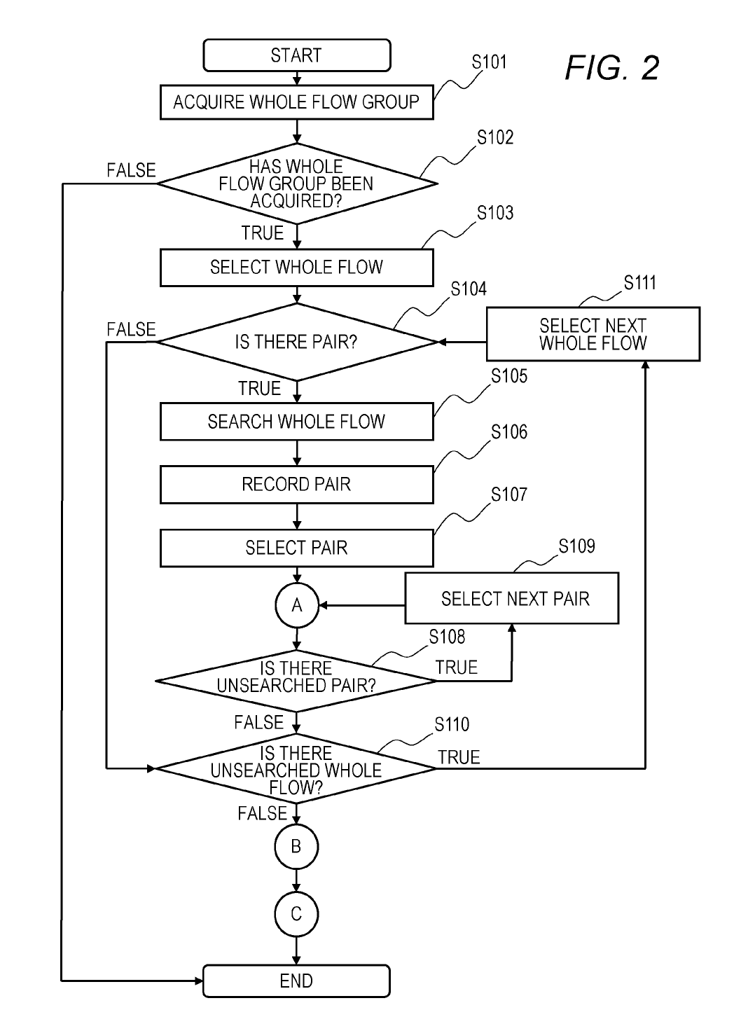

FIG. 2 illustrates a series of processes performed by the assist apparatus 100.

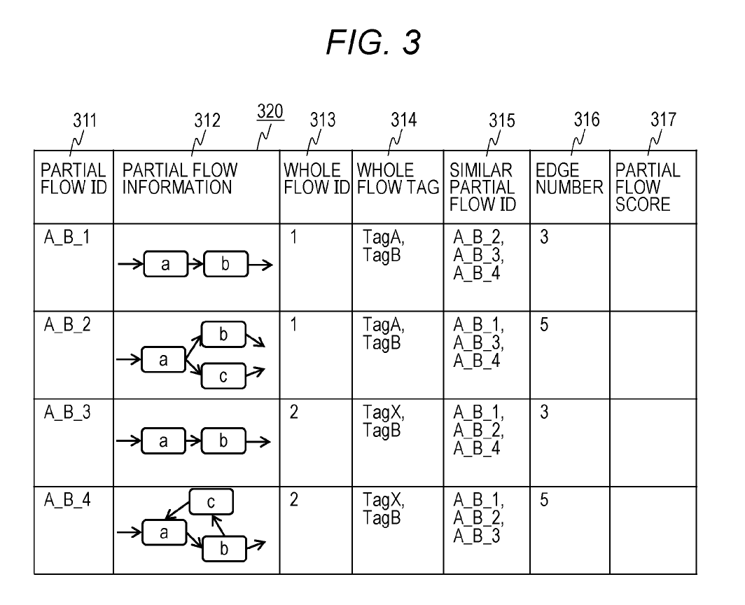

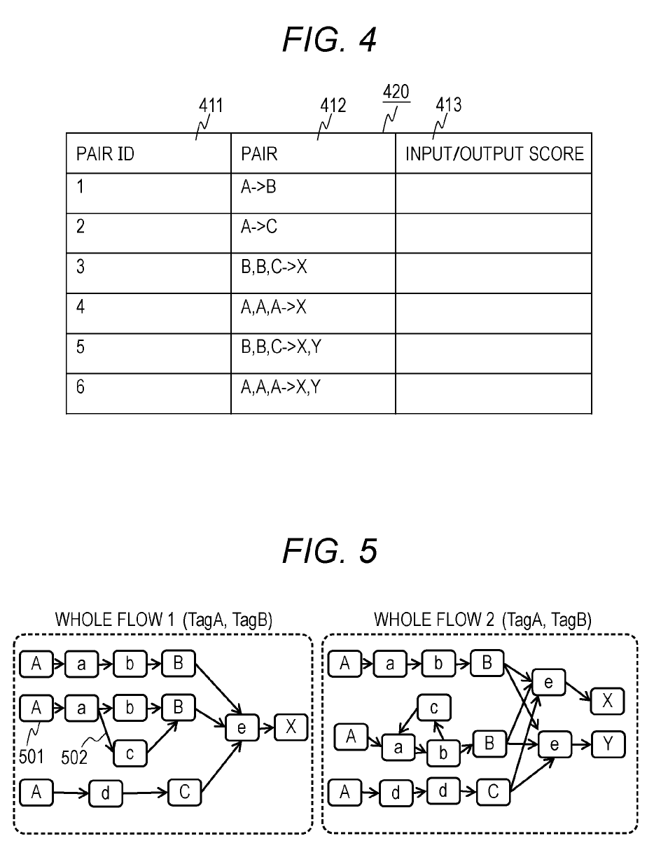

In the series of processes, tables such as a partial flow score table 320 (for example, see FIG. 3) and an input/output score table 420 (for example, see FIG. 4) are created.

The partial flow score table 320 is a table storing information on a partial flow between a node as a start point and a node as an end point, and exists for each start/end pair which is a pair of the node as the start point and the node as the end point. For example, FIG. 3 is a partial flow score table for a start/end pair of a node A as a start point and a node B as an end point. According to the table, four partial flows exist for this pair. The partial flow score table 320 includes a partial flow ID column 311, a partial flow information column 312, a whole flow ID column 313, a whole flow tag column 314, a similar partial flow ID column 315, an edge number column 316, and a partial flow score column 317. The partial flow ID column 311 is a column in which an ID of a partial flow is recorded. The partial flow information column 312 is a column in which the own information of the partial flow is recorded. The whole flow ID column 313 is a column in which an ID of the whole flow that is an information source for extracting a partial flow is recorded. The whole flow tag column 314 is a column that handles information indicating a tag of the whole flow (hereinafter, a whole flow tag). Specifically, the “whole flow tag” is a type of a process such as reception of an HTTP request, use of a database, control of a motor, and the voice signal processing as described above. The similar partial flow ID column 315 is a column in which an ID of a partial flow similar to the partial flow is recorded. The edge number column 316 is a column in which the number of edges of the partial flow is recorded. The partial flow score column 317 is a column recording a score (partial flow score) to determine any of partial flows between the node as the start point and the node as the end point in the partial flow score table 320 to be preferentially presented as a design pattern. The partial flow score table 320 is stored in the storage unit 112.

The input/output score table 420 is a table storing information on the start/end pair of the node as the start point and the node as the end point. For example, information on six start/end pairs is recorded in the input/output score table 420 illustrated in FIG. 4. The input/output score table 420 includes a pair ID column 411, a pair column 412, and an input/output score column 413. There is an ID for a pair of nodes, and an ID of the start/end pair is recorded in the pair ID column 411. In the pair column 412, an ID of the start node and an ID of the end node are recorded. Neither the start node nor the end node constituting the start/end pair is limited to one. For example, in a start/end pair with a pair ID “5”, two nodes B and C are start nodes, and two nodes X and Y are end nodes. The input/output score column 413 records a score (input/output score) calculated for each node pair. The input/output score table 420 is stored in the storage unit 112.

Details of the processes illustrated in FIG. 2 will be described hereinafter.

In step S101, the partial flow detection unit 103 acquires a whole flow group (for example, all the files stored in the flow-saving repository 301) from the flow-saving repository 301. In step S102, the partial flow detection unit 103 determines whether even one whole flow has been acquired (whether there is at least one file that has been acquired). If a determination result of step S102 is “true”, the partial flow detection unit 103 selects any one whole flow among unselected whole flows in the series of processes in FIG. 2 in step S103, and the processing proceeds to step S104. If the determination result of step S102 is “false”, the partial flow detection unit 103 ends the series of processes.

Hereinafter, the processing of FIG. 2 will be described by exemplifying a case where two whole flows 1 and 2 illustrated in FIG. 5 have been acquired. Incidentally, a whole flow n is a whole flow with a whole flow ID “n”. The whole flow includes a plurality of nodes 501 and one or more edges 502.

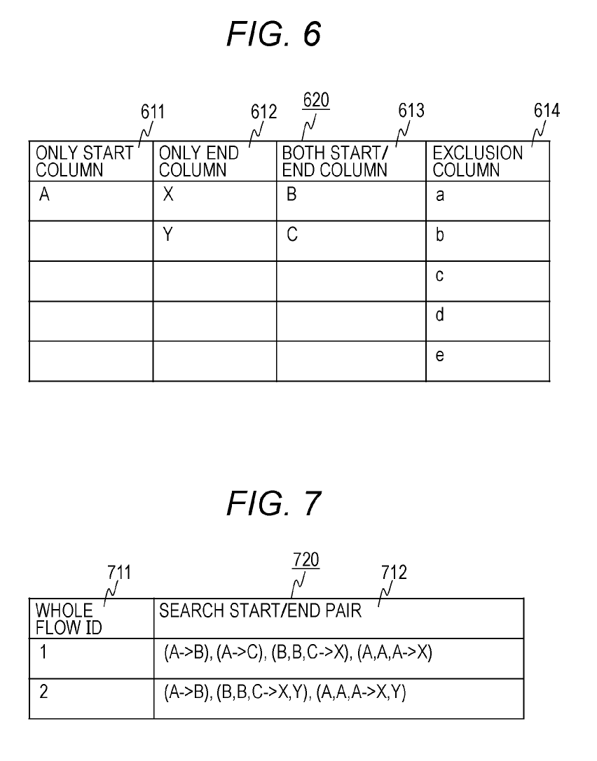

In step S104, the partial flow detection unit 103 determines whether a search start/end pair is present in the selected whole flow (the whole flow selected in step S103). The “search start/end pair” is a pair of a node to start search when searching the whole flow and a node to end the search. The search start/end pair is determined based on a search node table 620 (see FIG. 6). The search node table 620 includes: a column (only start column) 611 in which an ID of a search start node (node to start search) is recorded; a column (only end column) 612 in which an ID of a search end node (node to end search) is recorded; a column (both start/end column) 613 in which an ID of a search start/end node (node corresponding to both the search start node and the search end node) is recorded; and an exclusion column 614 in which an ID of a node that does not correspond to any of the search start node and the search end node is recorded. Each piece of information in the search node table 620 is information registered in advance from the arbitrary computer apparatus 400 in FIG. 1. Incidentally, a node having an ID other than the ID recorded in the columns 611 to 613 can be regarded as a node that does not correspond to any of the search start node and the search end node, and thus, the exclusion column 614 may be omitted. Further, the search start node corresponds to an input node, the search end node corresponds to an output node, and the search start/end node corresponds to an input/output node.

From the whole flow of FIG. 5 and the search node table 620 of FIG. 6, it is understood that a search start node group is {A, B, C} (nodes A, B, and C), a search end node group is {X, Y, B, C}, and excluded nodes are {a, b, c, d, e}. If the selected whole flow is the whole flow 1 in FIG. 5, the determination result of step S104 is “true” since the whole flow 1 in FIG. 5 includes both the nodes of the search start node group and the nodes of the search end node group (that is, since any head node of the whole flow 1 is the search start node A and a tail node of the whole flow 1 is the search end node X), and the processing proceeds to step S105. If the selected whole flow does not match a determination condition of step S104, the processing proceeds to step S110.

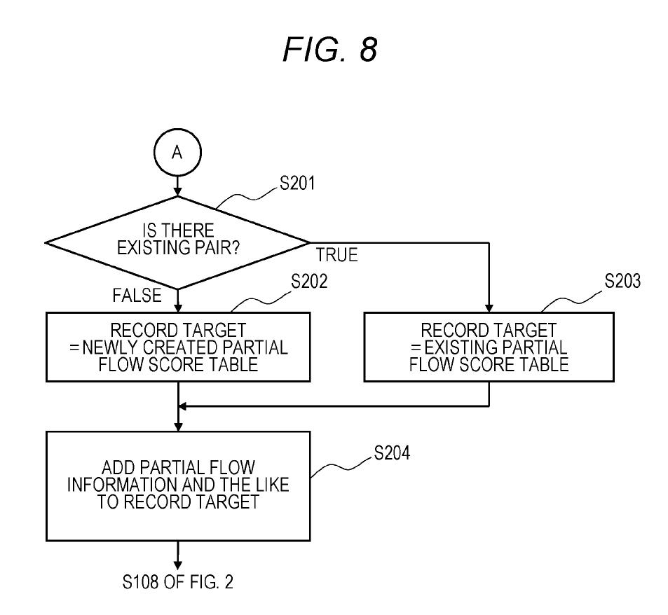

In step S105, the partial flow detection unit 103 searches for a route from a node in the search start node group to a node in the search end node group for the selected whole flow. When search is performed based on the search node table 620 of FIG. 6 for the whole flow 1 of FIG. 5, found are three routes from the node A to the node B, one route from the node A to the node C, two routes from the node B to the node X, one route from the node C to the node X, and three routes from the node A to the node X. Regarding the route from the node A to the node B, the partial flow detection unit 103 can determine that there is a start/end pair having the node A as the input node and the node B as the output node based on the input/output score table 420. In step S106, the partial flow detection unit 103 registers what kind of search start/end pairs are present for the whole flow in a search start/end pair table 720 (see FIG. 7). The search start/end pair table 720 includes a column (whole flow ID column) 711 in which the whole flow ID is recorded and a column (search start/end pair column) 712 where information on the search start/end pair is recorded. For example, for the whole flow 1, the partial flow detection unit 103 registers “(A->B)” in the search start/end pair column 712 since there is the route from the node A to the node B, and further, registers “(A->C)” in the search start/end pair column 712 since there is the route from the node A to the node C.

However, the partial flow detection unit 103 does not register “(B->X)”, “(C->X)”, and “(A->X)” in the search start/end pair column 712 regarding the route from the node B to the node X, the route from the node C to the node X, and the route from the node A to the node X. For example, the node e on the route from the node B to the node X has an input edge other than an input edge (input edge of interest) connected to the search node B of interest. Not only data output from one node B but data output from three nodes which are two nodes B and one node C flows to the node X. In this case, the partial flow detection unit 103 assumes that the search start/end pair for the route from the node B to the node X is “(B, B, C->X). In this manner, when the node in the partial flow between the search start node of interest and the search end node of interest has the input edge other than the input edge of interest connected to the search node of interest, the partial flow detection unit 103 goes back to arrive at the search start node or the node corresponding to both the search start and end nodes based on the search node table 620 from each input edge other than the input edge of interest, and adds the found node to the search start node of interest (that is, registers an ID of the search start node of interest and an ID of the found node in the column 712 as the IDs of the search start nodes).

In step S107, the partial flow detection unit 103 selects any one search start/end pair (for example, (A->B)) among unsearched search start/end pairs from the search start/end pair table 720 for the whole flow 1, and the processing proceeds to processing A (step S201 in FIG. 8). FIG. 8 illustrates the processing A. In step S201, the partial flow score calculation unit 102 determines whether the partial flow score table 320 of the selected pair (the search start/end pair selected in step S107) is already present. When a determination result of step S201 is “false”, the partial flow score calculation unit 102 newly creates the partial flow score table 320 for the selected pair (A->B) and sets a recording target in step S204 to the table 320 in step S202. If the determination result in step S201 is “true”, the partial flow score calculation unit 102 sets the recording target in step S204 to the partial flow score table 320 for “(A->B)” that is already present in step S203.

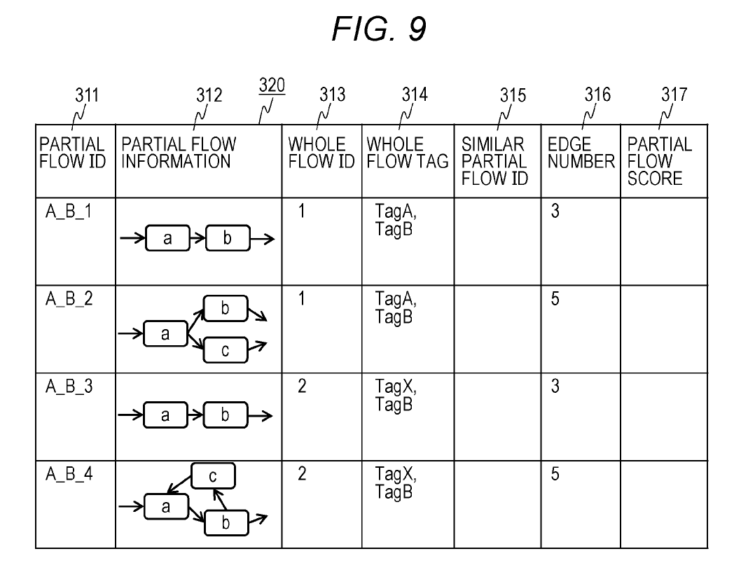

In step S204, the partial flow score calculation unit 102 searches for a partial flow between the nodes forming the selected pair, and adds the information to the partial flow information column 312, the whole flow ID column 313, the whole flow tag column 314, and the edge number column 316 of the partial flow score table 320 as the recording target. An existing method such as the method described in JP 2017-097698 A may be used as a method for searching the partial flow. For example, if a partial flow between the nodes A and B forming the selected pair (A->B) is searched from the whole flow 1 of FIG. 5, the partial flow score calculation unit 102 can obtain information that needs to be added to the partial flow information column 312, the whole flow ID column 313, the whole flow tag column 314, and the edge number column 316 for each of “A_B_1” and “A_B_2” in the partial flow ID column 311 in FIG. 9.

When the processing A ends, the processing proceeds to step S108 in FIG. 2. In step S108, the partial flow detection unit 103 determines whether there is an unsearched search start/end pair in the search start/end pair table 720. In FIG. 7, when the search for the search start/end pair (A->B) has been ended for the whole flow 1, a search start/end pair (A->C) is unsearched, and thus, determination result of step S108 is “true”, and the partial flow detection unit 103 selects the search start/end pair (A->C) in step S109. The processing A is executed for this pair (A->C). In this manner, the processing A is executed for each search start/end pair in a certain whole flow, and the partial flow score table 320 is created for each search start/end pair (if the partial score table 320 is already present for the search start/end pair, the table 320 is updated). When the processing A is executed for all the search start/end pairs, the determination result of step S108 is “false”, and the processing proceeds to step S110.

In step S110, the partial flow detection unit 103 determines whether there is a whole flow that has not been searched from steps S104 to S108. When the determination result of step S110 is “true”, the processing proceeds to step S111. As illustrated in FIG. 5, when the whole flow 2 is present next to the whole flow 1, the partial flow detection unit 103 selects the whole flow 2 in step S111.

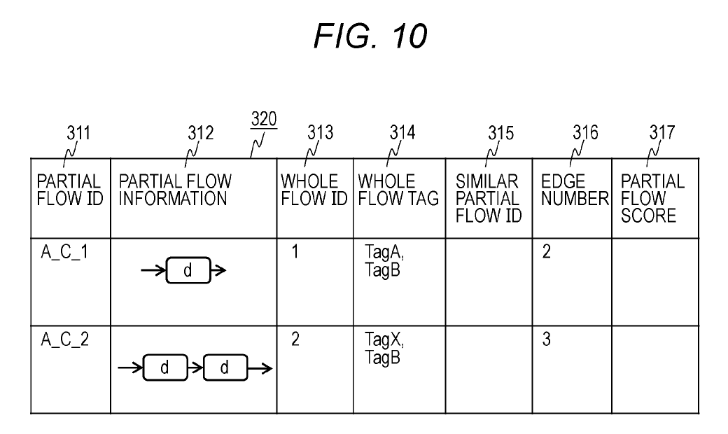

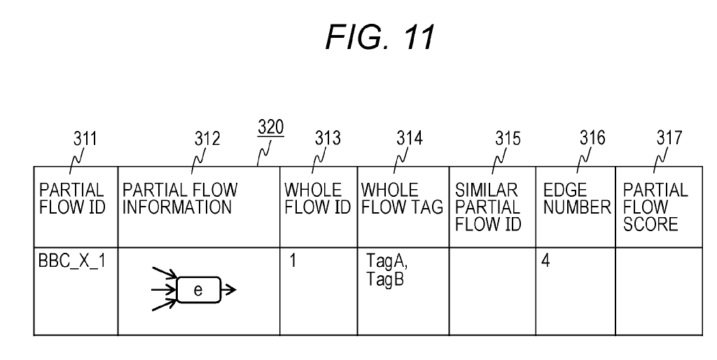

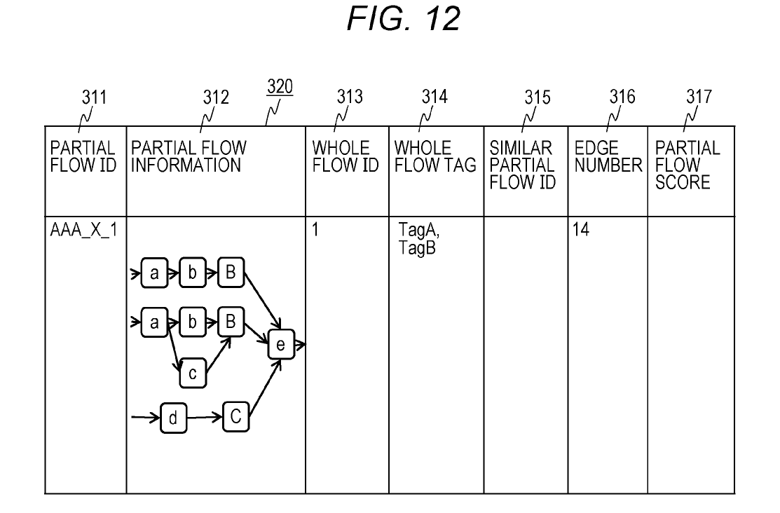

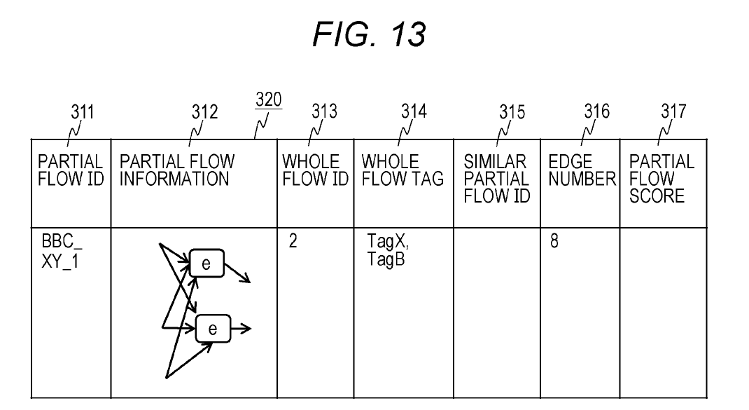

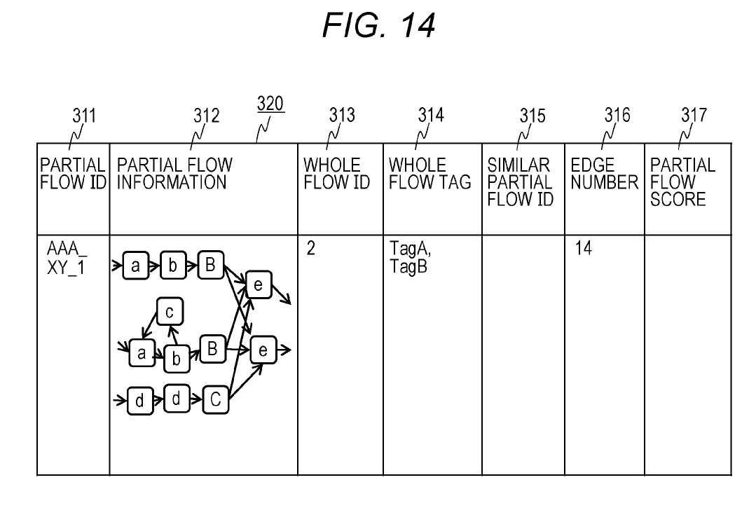

In this manner, steps S103 to S111 are performed for each of the whole flow 1 and the whole flow 2, and as a result, the partial flow score table 320 illustrated in FIGS. 9 to 14 is created (or updated). At this time, the information to be registered in the similar partial flow ID column 315 and the partial flow score column 317 has not yet been obtained as illustrated in FIGS. 9 to 14.

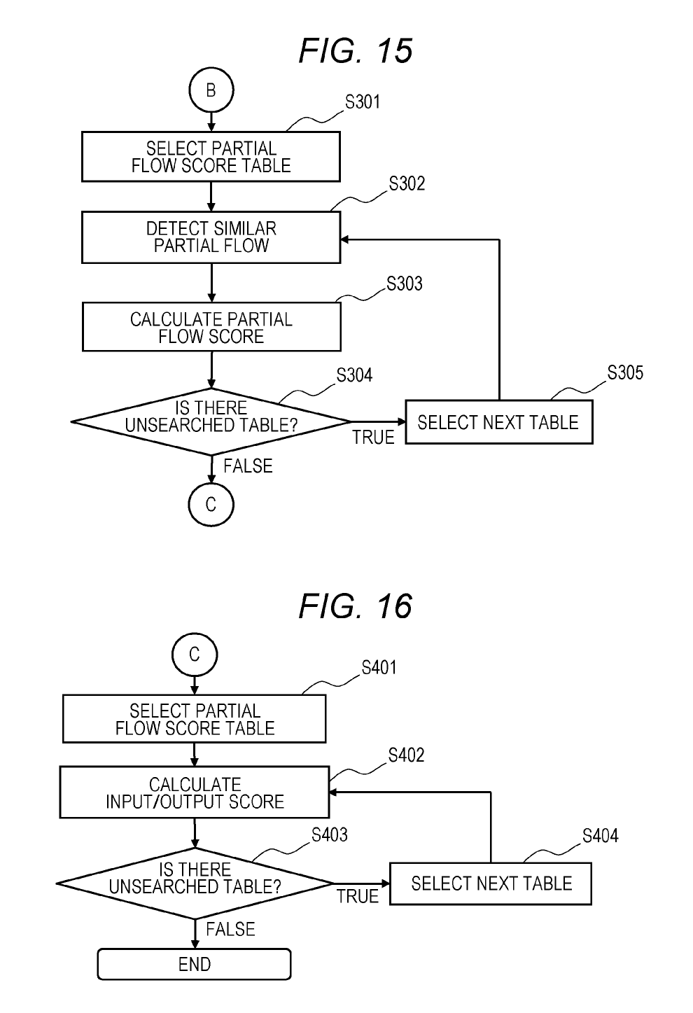

After the determination result of step S110 is “false”, the processing B (step S301 in FIG. 15) is executed. FIG. 15 illustrates the processing B. In step S301, the partial flow score calculation unit 102 selects any one partial flow score table 320 among the unselected partial flow score tables 320 of the created (or updated) partial flow score table 320 (for example, the partial flow score tables 320 illustrated in FIGS. 9 to 14). Here, it is assumed that the partial flow score table 320 (see FIG. 9) for the pair (A->B) is selected first. Then, in step S302, the partial flow similarity calculation unit 104 detects partial flows similar among partial flows present in the selected partial flow score table 320 (the partial flow score table 320 selected in step S301), and registers IDs of the similar partial flows in the similar partial flow ID column 317. Specifically, for example, the partial flow similarity calculation unit 104 calculates a similarity of the other partial flow for each of the other partial flows present in the selected partial flow score table 320 for each of the partial flows present in the selected partial flow score table 320, and determines whether to set the other partial flow as the similar partial flow depending on whether the similarity is lower than a threshold. According to the partial flow score table 320 for the pair (A->B) illustrated in FIG. 9, the partial flow A_B_1 and the partial flow A_B_3 match each other so that it is possible to determine that the partial flows are similar to each other. Further, the partial flow A_B_2 is obtained by adding one node c to the partial flow A_B_1 so that it is possible to determine that partial flows thereof are similar to each other. An existing method (for example, the method of JP 2017-097698 A or a method combining the methods of JP 2016-177667 A and JP 2017-097698 A) may be used as a method for determining the similarity between a partial flow and another partial flow. Meanwhile, it is assumed that a similarity (similarity between partial flows) is “1” when the partial flows completely match each other and takes a value of 0 to 1. Further, the threshold of the similarity for determining whether certain partial flows are similar to each other (that is, in the embodiment, a partial flow whose similarity with a certain partial flow is equal to or higher than the threshold is the similar partial flow for the certain partial flow) is set in advance by the arbitrary computer apparatus 400 in FIG. 1. The similarity lower than the similarity threshold (for example, 0.3) is truncated to be zero, and as a result, a partial flow whose similarity is lower than the threshold is not determined as the similar partial flow.

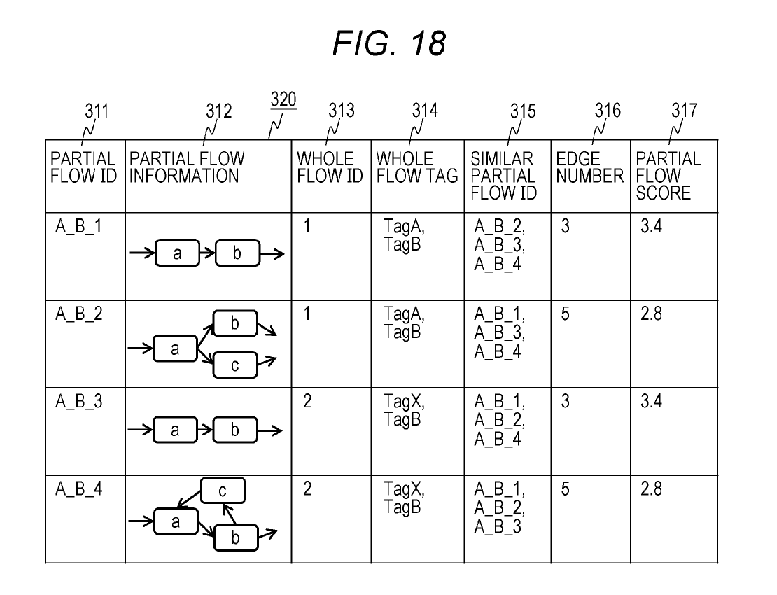

In step S303, the partial flow score calculation unit 102 calculates a partial flow score for each partial flow in the selected partial flow score table 320, and records the calculated partial flow score in the partial flow score column 317. For each partial flow, a partial flow score calculation formula of the partial flow is a value obtained by adding “1” to the sum of similarities of similar partial flows in the partial flow. For example, the partial flow score of the partial flow A_B_1 is (a similarity between the partial flows A_B_1 and A_B_2)+(a similarity between the partial flows A_B_1 and A_B_3)+(a similarity between the partial flows A_B_1 and A_B_4)+1. In a case where a similarity K between two partial flows is defined as K=1−0.1x (where K=0 when 1−0.1x is negative) when an operation of adding or deleting one node or edge to or from one partial flow is performed and the number of operations performed until being the same partial flow as the other partial flow is x, the partial flow score in the partial flow score table 320 for the pair (A->B) is given as illustrated in FIG. 18. In this manner, for each partial flow, the partial flow score tends to be higher as the number of similar partial flows is larger and to be higher as the similarity between the similar partial flows is higher in the embodiment. The reason why the partial flow score is higher as the number of similar partial flows is higher is considered that the probability of a whole flow to become a component of a design pattern is higher as the number of similar partial flows is higher, and as a result, it is considered that the probability of discovery of the design pattern becomes high. The reason why the partial flow score is higher as the similarity of each similar partial flow is higher that it is highly likely to be a partial flow with high general versatility, and as a result, it is considered that the probability of discovery of the design pattern is high.

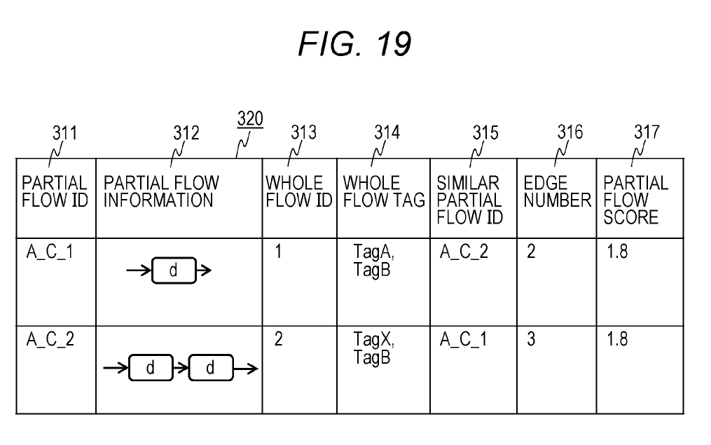

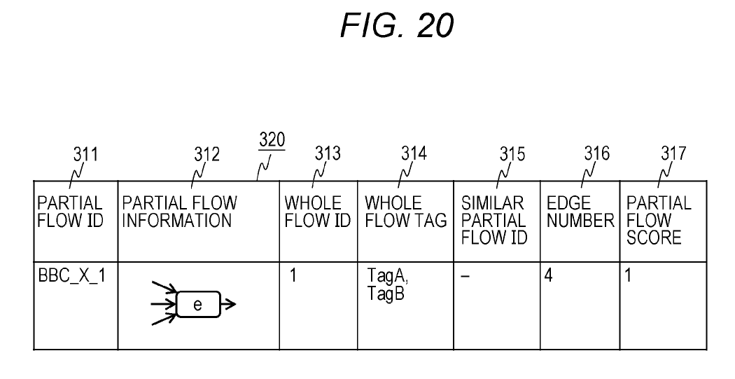

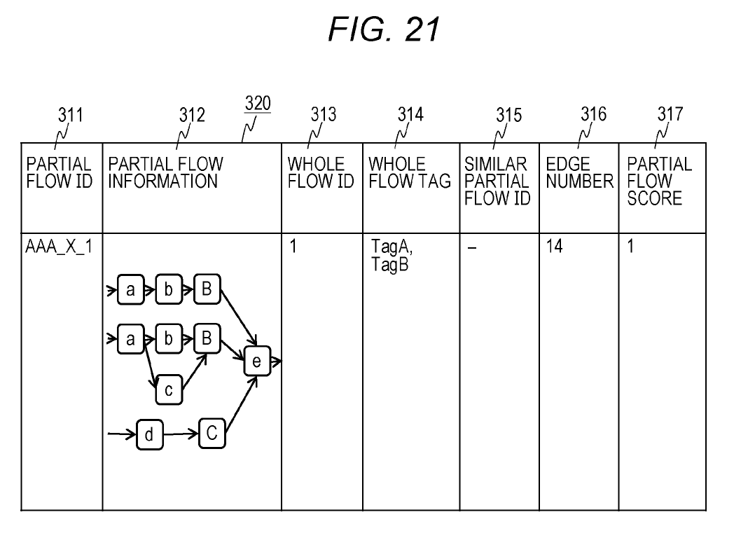

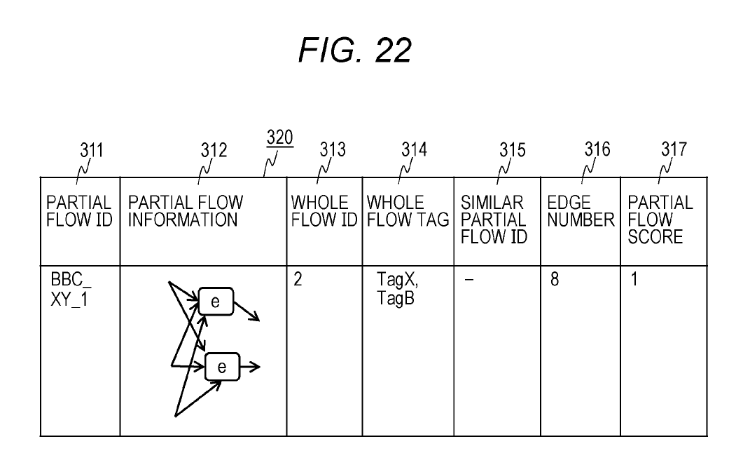

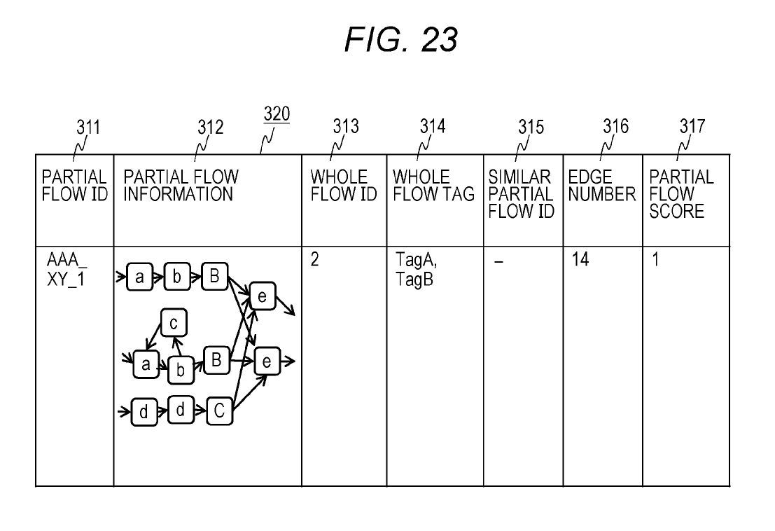

In step S304, the partial flow score calculation unit 102 determines whether there is the partial flow score table 320 for which the partial flow score has not been calculated (that is, the partial flow score table 320 unselected in step S301). If a determination result in step S304 is “true”, the partial flow score calculation unit 102 selects the next partial flow score table 320 in step S305, and calculates the partial flow score in steps S302 and S303 for the selected partial flow score table 320. When the determination result of step S304 is “false”, the information is written in the similar partial flow ID columns and the partial flow score columns of all the partial flow score tables 320 as illustrated in FIGS. 18 to 23. When the determination result of step S304 is “false”, the processing proceeds to processing C (step S401 in FIG. 16). FIG. 16 illustrates the processing C.

In step S401, the input/output score calculation unit 101 selects any one partial flow score table 320 out of the unselected partial flow score tables 320 from among the partial flow score tables 320 corresponding to all search start/end pairs on the search start/end pair table 720. In the description of FIG. 16, the partial flow score table 320 selected here is referred to as the “selected partial flow score table 320”, and the search start/end pair corresponding to the selected partial flow score table 320 is referred to as a “selected pair”.

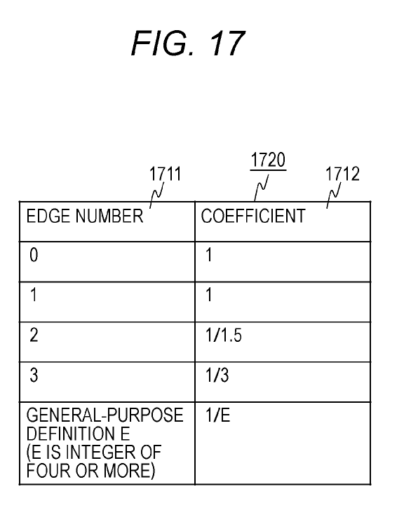

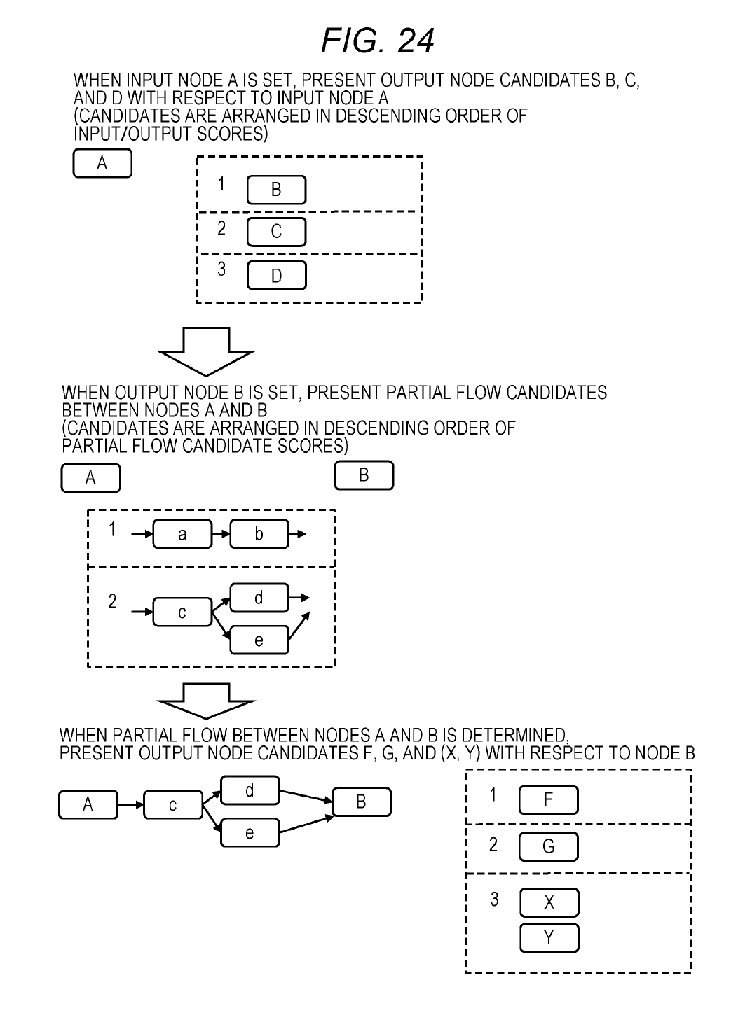

In step S402, the input/output score calculation unit 101 uses all edge numbers recorded in the edge number column 316 of the selected partial flow score table 320 to calculate an input/output score of the selected pair, and registers the calculated input/output score in a corresponding field (field corresponding to the selected pair) in the input/output score column 413 of the input/output score table 420. An input/output pair score calculation formula is a sum of values obtained by dividing each partial flow by a coefficient for an edge number in an edge coefficient table (table including a column 1711 in which the edge number is recorded and a column 1712 in which the coefficient (edge coefficient) corresponding to the edge number is recorded) 1720 illustrated in FIG. 17. For example, in the case of the partial flow score table 320 for a pair (A->B) in FIG. 9, an input/output score of the selected pair (A->B) can be calculated as ⅓+⅕+⅓+⅕. The edge coefficient table 1720 is registered in advance by an arbitrary computer apparatus 400 in FIG. 1. Since the edge coefficient is set, it is possible to adjust the order of candidate presentation in FIG. 24 which will be described later. In this manner, the input/output score tends to be higher as the number of partial flows is larger and to be lower as the number of edges in each partial flow is larger, for the selected pair in the embodiment. The reason why the input/output score is higher as the number of partial flows is larger is that there are many partial flow candidates between the input node and the output node as the number of partial flows increases, and as a result, it is considered that the probability of discovery of the design pattern is high. The reason why the input/output score is lower as the number of edges in each partial flow is larger is that the configuration of the partial flow tends to be more complicated as the number of edges is larger, and as a result, it is considered that the probability of discovery of the design pattern is low.

In step S403, the input/output score calculation unit 101 determines whether there is an input/output pair (search start/end pair) for which the input/output score has not been yet calculated (that is, whether there is the unselected partial flow score table 320). When a determination result in step S403 is “true”, the input/output score calculation unit 101 selects the input/output pair for which the score has not been calculated in step S404 (that is, selects any one partial flow score table 320 among the unselected partial flow score tables 320), and performs a score calculation process in step S402. When scores have been calculated for all the input/output pairs, the determination result of step S403 becomes “false,” and the processing in FIG. 2 is ended.

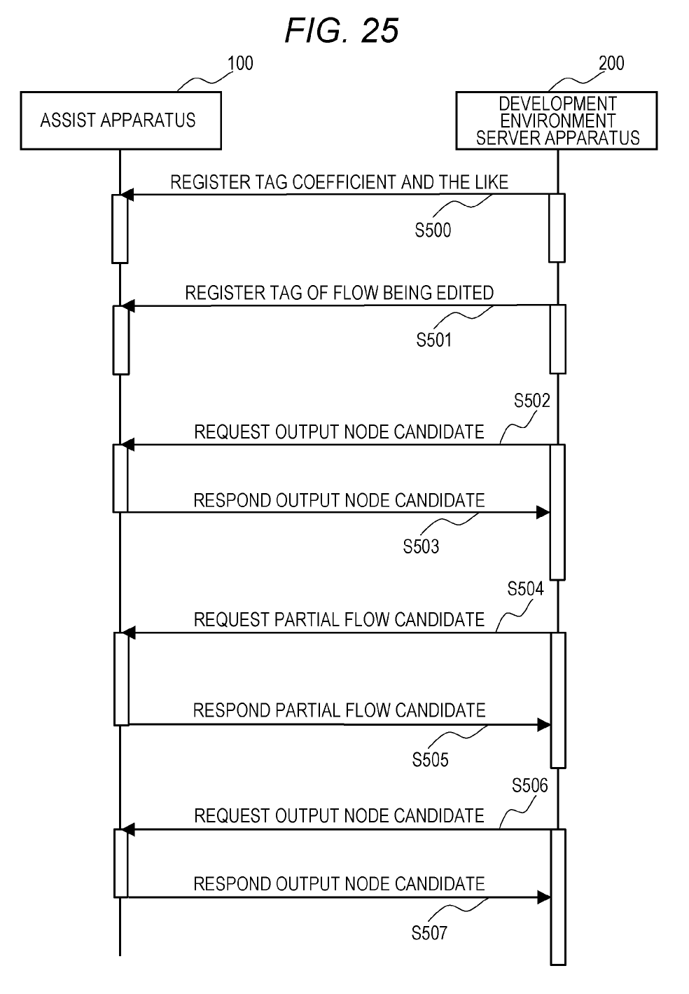

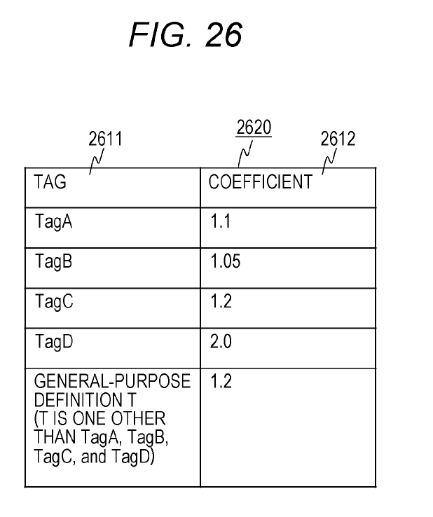

As illustrated in FIG. 1, the development environment server apparatus 200 requests candidate information, and the assist apparatus 100 returns the candidate information. This candidate information is calculated based on the information obtained in the processing of FIG. 2. A typical example of such candidate information is illustrated in FIG. 24. FIG. 25 illustrates the processing in a condition of FIG. 24 as a sequence diagram. In the following description, to place a node in the model development environment 201 means to select the node (select an object representing the node on a model development environment (for example, a user interface (UI)) such as a flow edit screen (for example, a graphical user interface (GUI)) provided by the model development environment 201. The selection (selection of the node and partial flow) and the candidate presentation are performed via the interface unit 111.

It is assumed that a search start node, a search end node, a tag coefficient, an edge coefficient, a similarity threshold, and a tag of a flow being edited are registered from the development environment server apparatus 200 to the assist apparatus 100 as illustrated in steps S500 and S501 of FIG. 25.

Further, it is assumed that a user (hereinafter, a developer) of the development environment server apparatus 200 places an input node A in the model development environment 201 (flow development environment) using a flow diagram. At this time, the model development environment 201 requests candidates of an output node following the input node A to the assist apparatus 100. This request corresponds to S502 in FIG. 25. Then, the candidate presentation unit 105 of the assist apparatus 100 refers to the input/output score table 420 to search for an input/output pair having the node A as the input node. For example, when there are three input/output pairs (A->B), (A->C), and (A->D) and levels of input/output scores are also set in this descending order, the candidate presentation unit 105 responds to the development environment server apparatus 200 with the order of these output nodes B, C, and D. This response corresponds to S503 in FIG. 25. Based on the response, the model development environment 201 presents output node candidates B, C, and D following the node A as illustrated in FIG. 24. Since (A->B), (A->C), and (A->D) are arranged in descending order of the input/output scores, the output node candidates are arranged in descending order of the input/output scores (in the order of the node B, the node C, and the node D) (see FIG. 24).

Next, when the developer selects the node B out of the presented candidates, the node B is placed in the flow being edited. At this time, the model development environment 201 requests a “candidate of a partial flow between the target pair (A->B)” to the assist apparatus 100. The reason why the target pair is (A->B) is that the node B has been selected as the output node for the input node A. This request corresponds to S504 in FIG. 25. Then, the candidate presentation unit 105 of the assist apparatus 100 refers to the partial flow score table 320 for the target pair (A->B). When a whole flow tag coinciding with a tag of the flow being edited (a tag input with respect to the model development environment 201) is present in the whole flow tag column 314, the candidate presentation unit 105 multiplies the partial flow score by a tag coefficient (tag coefficient corresponding to the coincident whole flow tag) recorded in the tag coefficient table (table including a column 2611 in which the whole flowing tag is recorded and a column 2612 in which a coefficient (tag coefficient) are recorded) 2620 illustrated in FIG. 26, for each partial flow belonging to the whole flow corresponding to the coincident whole flow tag. The tag coefficient table 2620 is the table recording the coefficient (tag coefficient) set for each whole flow tag and is registered (for example, stored in the storage unit 112) by the arbitrary computer apparatus 400 as illustrated in FIG. 1. Since the tag coefficient is set, it is possible to determine any type of flow to be preferentially presented.

For example, when tags of the flow being edited are TagA and TagB, a whole flow tag of a partial flow on the partial flow score table 320 is TagA, and a coefficient of TagA is set to 1.1 in the tag coefficient table 2620, the candidate presentation unit 105 acquires a value (hereinafter referred to as a partial flow candidate score) obtained by multiplying the partial flow score by 1.1. The partial flow candidate score of a partial flow corresponds to a partial flow score in which one or more tag coefficients respectively corresponding to one or more whole flow tags have been reflected when the one or more whole flow tags of the whole flow to which the partial flow belongs coincide with the tag of the flow being edited (for example, if the tags of the flow being edited are TagA and TagB, and the whole flow tags are not only TagA but also TagB, the partial flow score is also multiplied by a tag coefficient of TagA in addition to the tag coefficient of TagA). On the other hand, when the partial flow candidate score of a partial flow corresponds to the partial flow score itself when any whole flow tag of the whole flow to which the partial flow belongs does not coincide with the tag of the flow being edited. In this manner, when there is at least one coincident whole flow tag for the same partial flow, the partial flow candidate score is relatively higher as compared to the case where even one coincident whole flow tag is not present at all. In this manner, the candidate presentation unit 105 calculates the partial flow candidate scores based on whether there is the coincident whole flow tag for all the partial flows in a certain partial flow table. As described above, the partial flow score of the partial flow is obtained by adding “1” to the sum of similarities of all the similar partial flows of the partial flow. The reason for maintaining the partial flow score above “1” is to avoid a decrease of the partial flow candidate score of the partial flow having at least one coincident whole flow tag caused by multiplying the partial flow score by the tag coefficient.

As illustrated in S505 of FIG. 25, the candidate presentation unit 105 transmits a response including the partial flow candidate scores of all the partial flows specified from the partial flow score table 320 for the target pair (A->B) and the partial flow information of all the partial flows to the development environment server apparatus 200. In response to this response, the model development environment 201 presents partial flow candidates between the input node A and the output node B as illustrated in FIG. 24. The partial flows are arranged in descending order of the partial flow candidate scores (descending order).

Then, when one partial flow is selected out of the presented partial flow candidates by the developer, the model development environment 201 places the selected partial flow between input node A and output node B. In this case, an input edge of the selected partial flow is connected to the input node A, and an output edge of the selected partial flow is connected to the output node B in the model development environment 201.

When the output node B is the node that performs both the input and output (for example, when the model development environment 201 specifies that the node B is the node performing both the input and output based on the search node table 620), the model development environment 201 requests an “output node candidate for the node B” to the assist apparatus 100 as illustrated in S506 of FIG. 25, and a response for the request is returned as illustrated in S507. The response includes information obtained by referring to the input/output score table 420 with the node B as an input node (information including an output node and an input/output score for each pair having the node B as the input node). Then, the model development environment 201 presents output node candidates following the node B. These candidates are also arranged in descending order of input/output scores (descending order).

In this manner, the developer can discover the design pattern by repeating the selection of the input node, the presentation and selection of the output node candidate, and the presentation and selection of the partial flow candidate between the input node and the output node. It is possible to realize the efficient development based on the discovered design pattern.

Although one embodiment has been described above, this is an example for describing the invention, and there is no intention to limit the scope of the invention only to the embodiment. The invention can be implemented in various other forms.

For example, an input node candidate may be presented after the output node is placed, instead of presenting the output node candidate after the input node is placed. Such processing regarding presentation of the input node candidate can be understood by replacing the output node with the input node in the above description on the processing regarding the presentation of the output node candidate (for example, steps S502 to S503).

Further, for example, the tag coefficient may be reflected in the input/output score depending on presence or absence of the whole flow tag coinciding with the tag of the flow being edited for each pair including the placed input node (or output node) in the processing regarding the presentation of the candidates of the output node (or input node), instead of or in addition to the processing regarding the presentation of the partial flow candidate. That is, the candidates of the output node (or input node) may be arranged in descending order of input/output candidate scores (input/output scores directly or scores reflecting the tag coefficients in the case of presence of the coincident whole flow tag). In this case, the input/output score may be maintained at “1” or larger, which is similar to the partial flow score. For each pair including the placed input node (or output node), the input/output candidate score may tend to be higher as the number of whole flows having the whole flow tags coinciding with the tags of the flow being edited is larger (as the number of coincident whole flow tags is larger).

Further, for example, an object indicating a candidate (an output node (or input node) or a partial flow) having a coincident whole flow tag may be highlighted and displayed depending on presence or absence of the coincident whole flow tag or depending on the number of coincident whole flow tags. As a result, the developer can quickly understand candidates based on the whole flow having at least one whole flow tag coinciding with the tag of the flow being edited. In this case, the candidate presentation unit 105 may cause the response to be transmitted to the development environment server apparatus 200 to include information indicating the number of coincident whole flow tags for each candidate. The degree of highlighted display may differ depending on to the number of coincident whole flow tags.

Further, for example, there may be an upper limit on the number of displayable candidates (for example, upper M (M is a natural number)) as a candidate of an output node (or input node) or a partial flow, and a candidate list may be viewed by scrolling or the like.

What is claimed is:

1. A computer program for causing a computer apparatus to execute:
(A) presenting one or more second node candidates, which are one or more candidates of a second node, when a first node is selected regarding a flow being edited in a model development environment using a flow diagram,
the first node being any node corresponding to one type of an input node and an output node,
the second node being a node corresponding to the first node among nodes corresponding to any type between a node of another type between the input node and the output node, and an input/output node which is a type of node serving as both the input node and the output node; and
(B) presenting one or more partial flow candidates, which are one or more candidates of a partial flow between the first node and the second node, when any second node candidate is selected as the second node from the one or more second node candidates.

2. The computer program according to claim 1 for causing the computer apparatus to execute
when the selected second node corresponds to the input/output node, (A) using the second node as another first node.

3. The computer program according to claim 1, wherein
the one or more second node candidates are arranged in descending order of input/output candidate scores,
for each of the one or more second node candidates, the input/output candidate score of the second node candidate is a score of a pair formed of the first node and the second node candidate, the score based on all existing whole flows,
the one or more partial flow candidates are arranged in descending order of partial flow candidate scores, and
for the one or more partial flow candidates, the partial flow candidate score of the partial flow candidate is a score of the partial flow candidate, the score based on a partial flow corresponding to a partial flow candidate among all partial flows present between a pair of the first node and the second node in all the whole flows.

4. The computer program according to claim 3, wherein
for each of the one or more second node candidates, the input/output candidate score of the second node candidate tends to be higher as a number of partial flows present between the pair of the first node and the second node candidate is larger, and to be lower as a number edges in each partial flow present between the pair of the first node and the second node candidate is larger.

5. The computer program according to claim 3, wherein
for each of the one or more partial flow candidates, the partial flow candidate score of the partial flow candidate tends to be higher as a number of similar partial flows, which are partial flows similar to the partial flow candidate is larger among partial flows present between the pair of the first node and the second node candidate, and to be higher as a similarity of each of the similar partial flows is higher.

6. The computer program according to claim 3, wherein
for each of the one or more second node candidates, the input/output candidate score of the second node candidate tends to be higher as a number of whole flow tags coinciding with a tag indicating a type of processing of the flow being edited is larger among whole flow tags associated with whole flows including the pair of the first node and the second node candidate, and
for each of the whole flows, the whole flow tag associated with the whole flow indicates a type of processing of the whole flow.

7. The computer program according to claim 3, wherein
for each of the one or more partial flow candidates, the partial flow candidate scores of the partial flow candidate tends to be higher as a number of whole flow tags coinciding with a tag indicating a type of processing of the flow being edited is larger among whole flow tags associated with whole flows including the partial flow candidate in the pair of the first node and the second node, and
for each of the whole flows, the whole flow tag associated with the whole flow indicates a type of processing of the whole flow.

8. The computer program according to claim 1, wherein
in (A), a tag-coincident second node candidate out of the one or more second node candidates is emphatically displayed,
the tag-coincident second node candidate is a second node candidate forming a pair included in a whole flow associated with a whole flow tag coinciding with a tag indicating a type of processing of the flow being edited, the second node candidate forming the pair with the first node, and
for each of the whole flows, the whole flow tag associated with the whole flow indicates a type of processing of the whole flow.

9. The computer program according to claim 1, wherein
in (B), a tag-coincident partial flow candidate out of the one or more partial flow candidates is emphatically displayed,
the tag-coincident partial flow candidate is a partial flow included in a whole flow associated with a whole flow tag coinciding with a tag indicating a type of processing of the flow being edited, and
for each of the whole flows, the whole flow tag associated with the whole flow indicates a type of processing of the whole flow.

10. The computer program according to claim 3 causing the computer apparatus to further execute:
reading all the whole flows;
searching for a pair of an input node and an output node for each of the whole flows;
detecting a partial flow present between the pair for each of the searched pairs;
detecting a similar partial flow based on a similarity with each of other partial flows from all the other partial flows between the pair for each of the detected partial flows;
calculating a partial flow score based on the similarity of each of the similar partial flows; and
calculating an input/output score of the pair based on each of the partial flows between the pair, wherein
for each of the one or more second node candidates, the input/output candidate score of the second node candidate is a score depending on an input/output score of the pair formed of the first node and the second node candidate, and
for each of the one or more partial flow candidates, the partial flow candidate score of the partial flow candidate is a score depending on the partial flow score of the partial flow candidate.

11. A design pattern discovery assist apparatus comprising:
an interface unit; and
a processor unit connected to the interface unit, wherein
the processor unit executes:
(A) presenting one or more second node candidates, which are one or more candidates of a second node, via the interface unit when a first node is selected via the interface unit regarding a flow being edited in a model development environment using a flow diagram,
the first node being any node corresponding to one type of an input node and an output node,
the second node being a node corresponding to the first node among nodes corresponding to any type between a node of another type between the input node and the output node, and an input/output node which is a type of node serving as both the input node and the output node; and
(B) presenting one or more partial flow candidates, which are one or more candidates of a partial flow between the first node and the second node, via the interface unit when any second node candidate is selected, via the interface unit, as the second node from the one or more second node candidates.

12. A method for assisting discovery of a design pattern, the method comprising:
(A) presenting one or more second node candidates, which are one or more candidates of a second node, when a first node is selected regarding a flow being edited in a model development environment using a flow diagram,
the first node being any node corresponding to one type of an input node and an output node,
the second node being a node corresponding to the first node among nodes corresponding to any type between a node of another type between the input node and the output node, and an input/output node which is a type of node serving as both the input node and the output node; and
(B) presenting one or more partial flow candidates, which are one or more candidates of a partial flow between the first node and the second node, when any second node candidate is selected as the second node from the one or more second node candidates.
